(19) United States
(12) Patent Application Publication
(10) Pub. No.: US 2013/0049398 A1
(43) Pub. Date: Feb. 28, 2013

(54) CAMPING TRAILER

(71) Applicant: Sung Hyun PARK, Pocheon-si (KR)

(72) Inventor: Sung Hyun PARK, Pocheon-si (KR)

(21) Appl. No.: 13/594,463

(22) Filed: Aug. 24, 2012

(30) Foreign Application Priority Data
Aug. 25, 2011 (KR) 10-2011-0085088

(51) Int. Cl. B60P 3/355

(52) U.S. Cl. 296/171; 296/173; 296/26.05

(57) ABSTRACT

Provided is a camping trailer including an upper frame body, a lower frame body, and a roof frame body all of which are configured to have an identical structure, in which all the upper, lower, and roof frame bodies are extended to be spread or folded to be reduced by an effector body. Accordingly, the camping trailer is not only transported conveniently with a minimized volume thereof during transportation or carriage by reducing the lower, upper, and roof frame bodies thereof to thus enhance improvement of mobility, but also secures a living space with a maximized volume thereof by extending the reduced lower, upper, and roof frame bodies thereof during use, in all directions to thus enhance improvement of space usability.

### BACKGROUND OF THE INVENTION

1. Field of the Invention

The present invention relates to a camping trailer, and more particularly, to a camping trailer that cannot only minimize volume thereof during transportation or carriage by reducing a lower frame body, an upper frame body, and a roof frame body of the camping trailer, but also maximize the volume thereof by extending the reduced lower, upper, and roof frame bodies thereof during use, to thus enhance improvement of usability.

2. Description of the Related Art

In general, since the living standards of the moderns are being gradually improved, it has emerged as their concerns how to spend a lot of leisure time. In this connection, most people would spend their leisure time outdoors such as rivers, mountains, or green fields with family or friends. However, sleeping accommodations or facilities are limited at places of interest where crowds are gathered all at a time, to thus cause a great inconvenience to those who have sought there.

Thus, recreational vehicles (RVs) are being rapidly spread and used in recent days. The recreational vehicles (RVs) are called camping cars, camping trailers, or camping automobiles, campers or motorized caravans in which a container-shaped housing unit equipped with life facilities or tools such as beds and kitchen is provided in a vehicle, to thereby enable users to stay or sleep in the vehicle parked at a desired place without restraint of places.

Most of the conventional recreational vehicles (RVs) are configured to have a vehicle unit and a housing unit so as to be separated from each other. In this case, the housing unit is loaded in a cargo loading space region at the vehicle's rear portion during transportation of the conventional recreational vehicles (RVs), and the former is separated from the latter to then be stood up on the ground at a place where users to stay or sleep. This may cause a complexity of the structure of the vehicle and thus cause an increase of the price of the vehicle, to accordingly charge an economic burden to users and incur occurrence of frequent failures.

Moreover, the conventional recreational vehicles (RVs) may cause a problem of limiting use of a space region in which a large space region is not available for users who need a variety of convenient or residential facilities.

Thus, bedrooms may be placed on the roofs of vehicles such as vans or sports utility vehicles (SUVs) and a variety of amenities may be equipped therein. However, this may also cause a narrow space problem that the spaces of the bedrooms are still narrow, and thus may not significantly improve utilization of space.

According to the conventional art, a side panel transportation device for use in a conventional recreational vehicle (RV) was disclosed in the Korean Patent No. 10-1040088. The side panel transportation device is applied to the recreational vehicle (RV) that includes a main body, a side panel that is provided on the left or right side of the main body, and a corrugate folding plate surrounding the ceiling surface of the side panel and the front-side and rear-side surfaces thereof. Here, the side panel is transported outwardly in the left and right sides by a reinforcing plate that performs a sliding movement by a single power source. The reinforcing plate is a support unit that can perform a sliding movement to the left and right sides and is connected to a base substrate on the bottom of the recreational vehicle (RV). A drive unit that extends the side panel outwardly in the left and right sides thereof, is provided on the lower surface of the base substrate. The drive unit includes a motor having a drive gear and generating power that makes the side panel move simultaneously outwardly in the left and right sides, an interlocking spur gear that interlocks with the motor having the drive gear, and a rotary shaft that receives power transferred to the interlocking spur gear and performs a screw-movement back and forth. Both ends of the rotary shaft are combined with a bearing housing. A nut housing that moves along the rotary shaft is fixed on the bottoms of first and second reinforcement plates that form the left and right sides of the reinforcing plate that is separably formed.

According to the conventional art having the above-described structure, the side panel is transported by the corrugate folding plate at a state where front-side and rear-side surfaces are folded during transportation, and the front-side and rear-side surfaces of the side panel are unfolded during use after transportation to thereby form a large space.

However, according to the conventional art, a configuration that works the corrugate folding plate is complicate. Accordingly, much economic burden is charged to users who intend to purchase recreational vehicles (RVs). Further, a space is secured only at both sides of a vehicle, to thereby make it difficult to secure a wide space.

### SUMMARY OF THE INVENTION

To overcome problems or inconveniences of camping trailers according to the conventional art, it is an object of the present invention to provide a camping trailer that is connected to the rear side of a vehicle so as to be transported and comprises a lower frame body, an upper frame body, and a roof frame body all of which are extended to secure a space at maximum, to thus make it possible to secure a living space at a camping place, minimize the entire volume thereof during transportation or carriage by reducing the extended lower frame body, upper frame body, and roof frame body thereof, to allow easy transportation, and minimize a purchasing cost burden by a simple configuration.

Other objects of the present invention are not limited to the above-mentioned object, but it will be obvious to those who are skilled in the art that the other objects will be clearly understood from the following description.

To accomplish the above object of the present invention, according to an aspect of the present invention, there is provided a camping trailer comprising:

a lower frame body 10 comprising four lower frames 11 that are cross-coupled with one another, and four extendible frames 12 that are respectively drawn into and out from inner sides of the four lower frames 11;

an effector body 20 that is coupled to the four lower frames 11 of the lower frame body 10 to thus ensure that the four extendible frames 12 are respectively drawn into and out from inner sides of the four lower frames 11;

four vertical cylinders 30 whose bottoms are respectively connected to the edges of the four extendible frames 12;

an upper frame body 40 whose bottom edges are respectively connected to the upper ends of the four vertical cylinders 30 and that are extended by extending the lower frame body 10 in the same manner as that of the lower frame body 10; and

a roof frame body 50 that is connected on top of the upper frame body 40 and is extended in the same manner as that of the upper frame body 40.

Preferably but not necessarily, the effector body 20 comprises:

cylinder rods 22 that are fixedly connected to the four extendible frames 12 by brackets 21, respectively; and

cylinders 23 that are respectively fixed to the four lower frames 11, to thus allow the cylinder rods 22 to draw into and out from the cylinders 23 so that the four extendible frames 12 are respectively drawn into and out from inner sides of the four lower frames 11.

Preferably but not necessarily, the upper frame body 40 comprises:

four withdrawal frames 41 whose bottom edges are respectively connected to the upper ends of the four vertical cylinders 30; and

four support frames 42 into the inner portions of which the four withdrawal frames 41 are respectively fitted and supported, and into and out from which the four withdrawal frames 41 are drawn and cross-coupled with one another.

Preferably but not necessarily, the roof frame body 50 comprises:

four first frames 51 whose bottoms are respectively connected to the edges of the upper frame body 40; and

four second frames 52 into the inner portions of which the four first frames 51 are respectively fitted and supported, and into and out from which four first frames 51 are drawn and cross-coupled with one another.

Preferably but not necessarily, the four vertical cylinders 30 further comprises:

a number of curtain support frames 61 that cross-links the four vertical cylinders 30 with one another;

connection wires 62 that connect the curtain support frames 61 vertically; and

curtains 63 that are coupled to the curtain support frames 61, respectively.

### BRIEF DESCRIPTION OF THE DRAWINGS

The above and/or other aspects of the present invention will become apparent and more readily appreciated from the following description of the exemplary embodiments, taken in conjunction with the accompanying drawings in which:

FIG. 1 is a perspective view showing structure of a camping trailer according to an embodiment of the present invention;

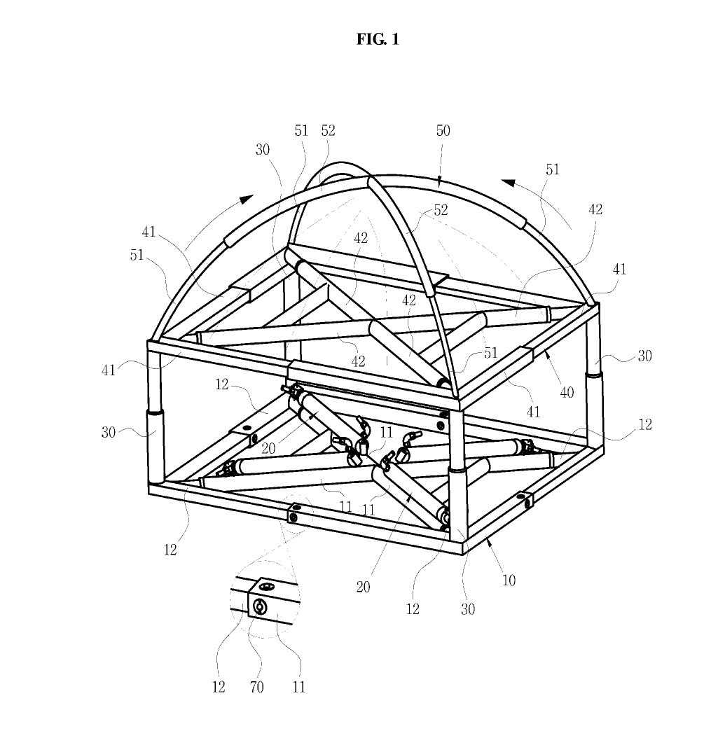

FIG. 2 is a perspective view showing a lower frame body of the camping trailer of FIG. 1;

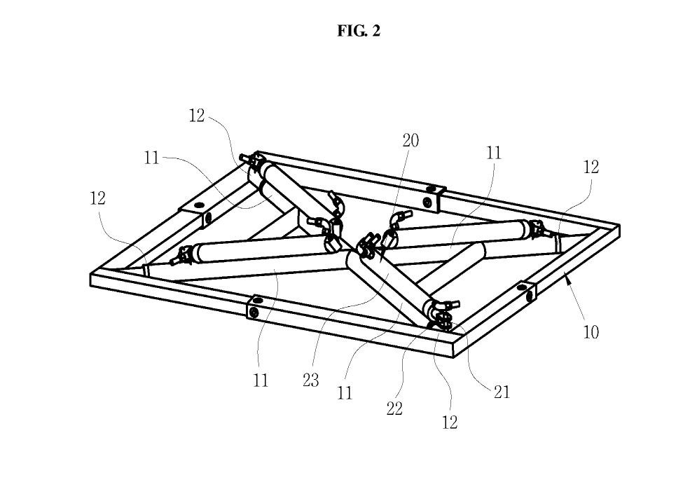

FIG. 3 is a plan view showing an extended state of the lower frame body of the camping trailer of FIG. 1;

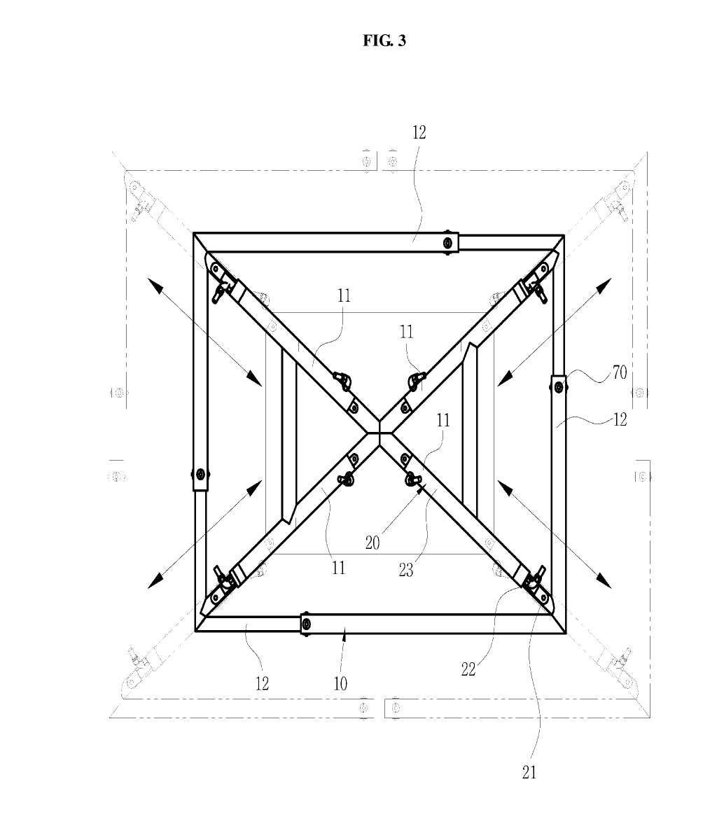

FIG. 4 is a front view showing the camping trailer of FIG. 1; and

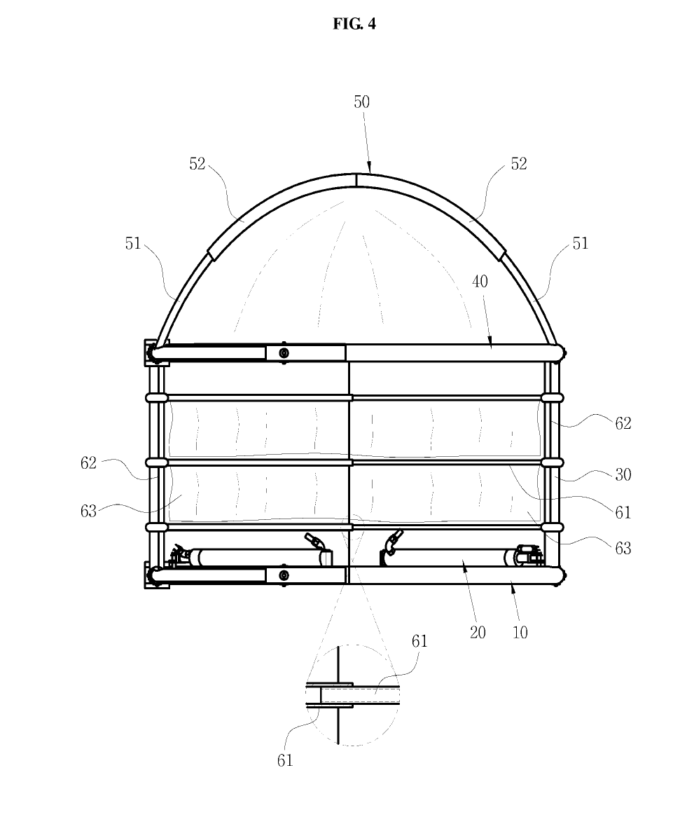

FIG. 5 is a plan view showing a reduced state of a lower frame body having bearing bodies in a camping trailer according to another embodiment of the present invention.

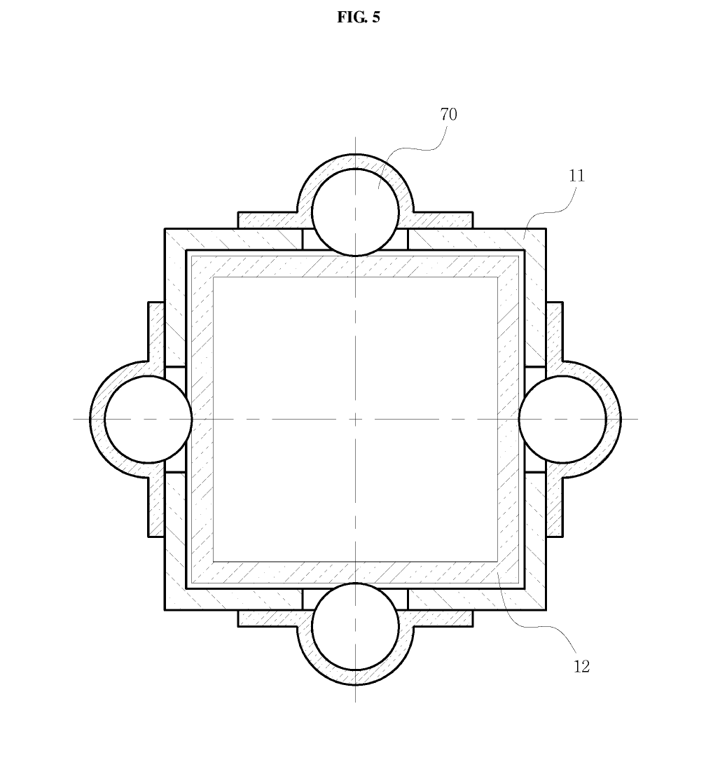

### DETAILED DESCRIPTION OF THE INVENTION

The nature, advantages and various additional features of the invention will appear more fully upon consideration of the illustrative embodiments now to be described in detail with the accompanying drawings. However, the present invention is not limited to the following embodiments but will be embodied in various forms.

That is, the embodiments of the present invention play a role of making the disclosure of the present invention perfect, and are provided to inform a person who has an ordinary knowledge and skill in a technological field to which this invention belongs of a category of the invention. This invention should be defined based on the scope of claims. Like numbers refer to like elements throughout the description of the figures.

Hereinafter, configuration and actions of the present invention will be described more specifically in accordance with the accompanying drawings. Terms and words used in this specification and claims should be interpreted as meanings and concepts to meet the technical ideas of the invention based on the principles that can define adequately the concept of the terms so that the inventor can explain his or her invention in the best way.

As shown, a camping trailer according to the present invention includes a lower frame body 10, an effector body 20, vertical cylinders 30, an upper frame body 40, and a roof frame body 50.

The lower frame body 10 includes four lower frames 11 that are cross-coupled with one another, and four extendible frames 12 that are respectively drawn into and out from inner sides of the four lower frames 11.

Moreover, wheels (not shown) for moving may be added more at the bottom of the lower frame body 10, and a connection unit (not shown) may be added at the outer side of the lower frame body 10 so as to be connected to a vehicle.

The effector body 20 is coupled to the four lower frames 11 of the lower frame body 10 to thus ensure that the four extendible frames 12 are respectively drawn into and out from inner sides of the four lower frames 11.

In other words, the lower frame body 10 is spread or contracted in four directions by operation of the effector body 20 to thus increase or reduce a volume thereof.

The vertical cylinders 30 include four vertical cylinders 30 whose bottoms are respectively connected to the edges of the four extendible frames 12 of the lower frame body 10, in which the upper frame body 40 is connected to the four vertical cylinders 30 so that the upper frame body 40 is positioned at the upper side of the lower frame body 10.

The bottom edges of the upper frame body 40 are respectively connected to the upper ends of the four vertical cylinders 30 and the upper frame body 40 is extended by extending the lower frame body 10 in the same manner as that of the lower frame body 10. Accordingly, the upper frame body 40 is also spread or folded in the same manner as in the lower frame body 10, to thereby enable the volume of the camping trailer according to the present invention to be increased or decreased.

The roof frame body 50 is connected on top of the upper frame body 40 and is extended in the same manner as that of the upper frame body 40.

In the camping trailer according to the present invention configured as described above, when the effector body 20 is activated, the four extendible frames 12 are drawn out from the four lower frames 11 constituting the lower frame body 10, to thereby allow lower frame body 10 to be extended.

In addition, the upper frame body 40 that is connected to the four extendible frames 12 via the vertical cylinders 30 is spread by withdrawing the four extendible frames 12 out from the four lower frames 11.

The upper frame body 40 includes four withdrawal frames 41 whose bottom edges are respectively connected to the upper ends of the four vertical cylinders 30, and four support frames 42 into the inner portions of which the four withdrawal frames 41 are respectively fitted and supported, and into and out from which the four withdrawal frames 41 are drawn and cross-coupled with one another.

The roof frame body 50 includes four first frames 51 whose bottoms are respectively connected to the edges of the upper frame body 40, and four second frames 52 into the inner portions of which the four first frames 51 are respectively fitted and supported, and into and out from which four first frames 51 are drawn and cross-coupled with one another. Accordingly, the four withdrawal frames 41 of the upper frame body 40 are withdrawn from the four support frames 42. As a result, the upper frame body 40 is also extended in the same manner as that of the lower frame body 10.

Moreover, the four first frames 51 of the roof frame body 50 are also withdrawn from the four second frames 52 thereof to then be extended.

Therefore, since the lower frame body 10, the upper frame body 40, and the roof frame body 50 are extended by the operation of the effector body 20 in the camping trailer according to the present invention, the volume of the camping trailer is maximized at a camping place after transportation, in order to secure a living space.

In addition, the lower frame body 10, the upper frame body 40, and the roof frame body 50 that have been extended to increase the volume of the camping trailer are reduced again before leaving a camping place after camping, so that the camping trailer can be transported with a minimized volume thereof. This is done by contracting the respective frame bodies that were extended by the effector body 20.

The effector body 20 includes cylinder rods 22 that are fixedly connected to the four extendible frames 12 by brackets 21, respectively, and cylinders 23 that are respectively fixed to the four lower frames 11, to thus allow the cylinder rods 22 to draw into and out from the cylinders 23 so that the four extendible frames 12 are respectively drawn into and out from inner sides of the four lower frames 11.

Thus, when the cylinder rods 22 are withdrawn by activation of the cylinders 23, the lower frame body 10, the upper frame body 40, and the roof frame body 50 are extended, while when the cylinder rods 22 are drawn by activation of the cylinders 23, the lower frame body 10, the upper frame body 40, and the roof frame body 50 are contracted to then be reduced.

In the camping trailer according to the present invention, the four vertical cylinders 30 further includes a number of curtain support frames 61 that cross-links the four vertical cylinders 30 with one another, connection wires 62 that connect the curtain support frames 61 vertically, and curtains 63 that are coupled to the curtain support frames 61, respectively.

Therefore, when the four vertical cylinders 30 are lifted up, the curtain support frames 61 that transversely connect the four vertical cylinders 30 rise up sequentially, to thus unfold the curtains 63 and to thereby hide the side surfaces of the camping trailer so that the camping trailer can be used at a state where it can be shielded from the outside.

Here, it is possible for the curtains 63 to be unfolded by the lifting-up and lifting-down operations of the curtain support frames 61 that are respectively connected by the connection wires 62.

In addition, the present invention is also configured to further include bearing bodies 70 in addition to the lower frame body 10. The unfolding and folding operations of the lower frame body 10 are more easily accomplished by the bodies 70. Further, it is of course that the camping trailer according to the present invention further includes a water chamber that contains drinking water or hot water in winter to perform a warming function, in a space that is formed by the lower frames 11 of the lower frame body 10.

As described above, the present invention has been described with respect to particularly preferred embodiments. However, the present invention is not limited to the above embodiments, and it is possible for one who has an ordinary skill in the art to make various modifications and variations, without departing off the spirit of the present invention. Thus, the protective scope of the present invention is not defined within the detailed description thereof but is defined by the claims to be described later and the technical spirit of the present invention.

### THE EFFECT OF THE INVENTION

A camping trailer according to the present invention includes an upper frame body, a lower frame body, and a roof frame body all of which are configured to have an identical structure, in which all the upper, lower, and roof frame bodies are extended to be spread or folded to be reduced by an effector body. Accordingly, the camping trailer is not only transported conveniently with a minimized volume thereof during transportation or carriage by reducing the lower, upper, and roof frame bodies thereof to thus enhance improvement of mobility, but also secures a living space with a maximized volume thereof by extending the reduced lower, upper, and roof frame bodies thereof during use, in all directions to thus enhance improvement of space usability.

What is claimed is:

1. A camping trailer comprising:
a lower frame body comprising four lower frames that are cross-coupled with one another, and four extendible frames that are respectively drawn into and out from inner sides of the four lower frames;
an effector body that is coupled to the four lower frames of the lower frame body to thus ensure that the four extendible frames are respectively drawn into and out from inner sides of the four lower frames;
four vertical cylinders whose bottoms are respectively connected to the edges of the four extendible frames;
an upper frame body whose bottom edges are respectively connected to the upper ends of the four vertical cylinders and that are extended by extending the lower frame body in the same manner as that of the lower frame body; and
a roof frame body that is connected on top of the upper frame body and is extended in the same manner as that of the upper frame body.

2. The camping trailer according to claim 1, wherein the effector body comprises:
cylinder rods that are fixedly connected to the four extendible frames by brackets, respectively; and
cylinders that are respectively fixed to the four lower frames, to thus allow the cylinder rods to draw into and out from the cylinders so that the four extendible frames are respectively drawn into and out from inner sides of the four lower frames.

3. The camping trailer according to claim 1, wherein the upper frame body comprises:
four withdrawal frames whose bottom edges are respectively connected to the upper ends of the four vertical cylinders; and
four support frames into the inner portions of which the four withdrawal frames are respectively fitted and supported, and into and out from which the four withdrawal frames are drawn and cross-coupled with one another.

4. The camping trailer according to claim 1, wherein the roof frame body comprises:
four first frames whose bottoms are respectively connected to the edges of the upper frame body; and
four second frames into the inner portions of which the four first frames are respectively fitted and supported, and into and out from which four first frames are drawn and cross-coupled with one another.

5. The camping trailer according to claim 1, wherein the four vertical cylinders further comprises:
a number of curtain support frames that cross-links the four vertical cylinders with one another;
connection wires that connect the curtain support frames vertically; and
curtains that are coupled to the curtain support frames, respectively.
